(19) United States
(12) Patent Application Publication
(10) Pub. No.: US 2026/0176481 A1
(43) Pub. Date: Jun. 25, 2026

(54) AQUEOUS COATING COMPOSITION COMPRISING AN AQUEOUS DISPERSION OF POLYAMIDE AS THICKENER

(71) Applicant: BASF COATINGS GMBH, Muenster (DE)

(72) Inventors: Christian ALTER, Muenster (DE); Cathrin CORTEN, Muenster (DE); Katharina FECHTNER, Muenster (DE); Klaus-Juergen KANNGIESSER, Muenster (DE); Dirk EIERHOFF, Muenster (DE)

(21) Appl. No.: 19/127,276

(22) PCT Filed: Oct. 17, 2023
(86) PCT No.: PCT/EP2023/078731

§ 371 Date: May 5, 2025

(30) Foreign Application Priority Data
Nov. 17, 2022 (EP) 22208068.1

(51) Int. Cl. C09D 7/44; C09D 5/36; C09D 7/65; C09D 7/80; C09D 133/10; C09D 167/00; C09D 175/12

(52) U.S. Cl. CPC C09D 7/44; C09D 5/36; C09D 7/65; C09D 7/80; C09D 133/10; C09D 167/00; C09D 175/12

(57) ABSTRACT

Disclosed herein is an aqueous coating composition including at least one binder (A) including at least one polymeric resin (A1), at least one pigment (B) and at least one thickener (C), where the thickener is an aqueous dispersion of a polyamide having a volume-based particle size distribution having an×10 quantile of at least 30 nm, an×50 quantile of at least 60 nm and an×90 quantile of at most 2000 nm. Also disclosed herein are a method of at least partly coating an optionally coated substrate with a basecoat film, a coating method of this kind, and a substrate coated accordingly.

The present invention relates to an aqueous coating composition comprising at least one binder (A) comprising at least one polymeric resin (A1), at least one pigment (B), and an aqueous dispersion of at least one polyamide as thicker. The present invention also relates to the use of the aqueous coating composition for at least partly coating an optionally coated substrate with a basecoat film, to a coating method of this kind, and to a substrate coated accordingly.

Particularly in automotive finishing, but also in other areas where the desire is for coatings with good decorative effect and advantageous mechanical properties like adhesion, it is known practice to endow substrates with a plurality of coating films disposed one above another. Multicoat paint systems are applied here preferably by the “basecoat/clearcoat” process—that is, a pigmented basecoat material is applied first of all, and after a short flashing time, without a baking step (wet-on-wet process), a clearcoat material is applied over it. Basecoat and clearcoat are subsequently baked together. The “basecoat/clearcoat” process has become particularly important in the application of automotive metallic effect paints.

For reasons of economics and environment, there is a requirement to use aqueous coating compositions when applying such multicoat paint systems, especially when applying the basecoat film.

The coating compositions for producing these basecoat films ought to be processible by the aforementioned “wet-on-wet” process—that is, after an extremely short preliminary drying time without a baking step, it ought to be possible to apply a clearcoat film over them without, in so doing, causing defects to the appearance, such as pinholes, bits and/or flow defects, for example. In order at least to minimize such defects, suitable rheological assistants, among other agents, are commonly used in the coating compositions that are to be applied.

In the case of metallic effect paints of the basecoat/clearcoat type, moreover, there are further requirements to be met as well. The metallic effect is dependent critically on the orientation of the metal pigment particles within the coating film. A metallic effect basecoat material to be processed in the “wet-on-wet” process, accordingly, must yield coating films in which, following application, the metal pigments are present in a favourable spatial orientation, and in which this orientation becomes rapidly fixed in such a way that it cannot be disrupted in the course of the further finishing operation. Suitable variables for characterizing the metallic effect are the lightness of the hue, and the flop index.

EP 0 877 063 A2 discloses aqueous coating compositions which comprise a polyamide in order to ensure sufficient sedimentation stability of the pigments present in the compositions. A disadvantage of the presence of such a polyamide as sole rheological assistant in aqueous coating compositions, however, is the incidence of bits, in particular, in the course of processing by means of the “wet-on-wet” process.

EP 1 153 989 A1 discloses aqueous coating compositions which as well as a polyamide, such as the commercially available polyamide Disparlon® AQ-600, include as further rheological assistant a metal silicate such as the commercially available metal silicate Laponite® RD, for example. A disadvantage of the presence of such a metal silicate in aqueous coating compositions, especially in combination with polyamides specified in EP 1 153 989 A1, however, is often the incidence of pinholes and/or bits in the case of processing by means of the “wet-on-wet” process.

EP 3 183 068 B1 discloses aqueous coating compositions containing a polyamide-based thickener. Aim is to achieve very good applications properties with at the same time no adverse influence on the metallic effect of the coating composition. The thickener is prepared by means of a mixture of a polyamide with a polymeric resin, namely a polyurethane resin in organic solvent, whereby the polyamide is added as a melt and whereby the resulting mixture then is admixed with water. In a last step, organic solvent is removed. Besides the fact that this procedure is rather complicated, it likewise means that the freedom in formulating the to be produced coating composition already is significantly limited, as a significant amount of a specific polyurethan resin (i.e. a binder resin) already is introduced via production of the thickener.

Also, it is generally known that polyamides, while having certain technical advantages when applied as thickeners (cf. above), a negative influence on in particular adhesion properties and appearance may occur. Also, storage stability remains a challenge.

There is therefore a demand for aqueous coating compositions, especially for coating compositions such as basecoat compositions, suitable for processing by means of the “wet-on-wet” process, that do not have the disadvantages identified above.

It is an object of the present invention, therefore, to provide an aqueous coating composition, more particularly an aqueous basecoat composition, which has advantages over the coating compositions known from the prior art. A particular object of the present invention is to provide a coating composition, which is notable for advantageous applications properties, and which is less of an environmental concern than compositions typically employed. Specifically, rheological properties should be outstanding, while concurrently negative influences on appearance, storage stability and adhesion as well as the incidence of bits should be avoided. Likewise, the freedom in formulating the composition should be high, meaning that no significant need to include adder resin compounds like being essential in EP 3 183 068 B1 should exist.

This object is achieved by the subject matter claimed in the claims and also by the preferred embodiments of this subject matter that are described in the description hereinafter.

A first subject of the present invention, therefore, is an aqueous coating composition comprising
at least one binder (A) comprising at least one polymeric resin (A1) and optionally
at least one crosslinking agent (A2),
at least one pigment (B), and
at least one thickener (C), for at least partly coating an optionally precoated substrate with a basecoat film, wherein the thickener (C) is an aqueous dispersion of a polyamide having a volume-based particle size distribution having an×10 quantile of at least 30 nm, an×50 quantile of at least 60 nm and an×90 quantile of at most 2000 nm.

It has surprisingly been found that the aqueous coating composition of the invention is suitable particularly in a “basecoat/clearcoat” process for applying a basecoat film to a substrate surface coated optionally with a priming coat and can therefore be used as a basecoat coating composition.

It has further surprisingly been found that by virtue in particular of the presence of the specific thickener (C) used in accordance with the invention, it is possible to prevent the incidence of pinholes, bits, and flow defects, which are often observed when typical rheological assistants such as Laponite®, for example, are used in combination with polyamides, or polyamides are used alone, as thickeners.

It has surprisingly emerged, moreover, that by virtue in particular of the presence of the specific thickener (C) used in accordance with the invention, there is no adverse influence on appearance, color shift, storage stability and adhesion properties.

Furthermore, the coating composition of the invention is distinguished by the fact that it is aqueous and hence less of an environmental concern than conventional coating compositions which comprise high fractions of organic solvents.

The terms “pops”, “pinholes”, “flop”, “bits”, “sedimentation”, and “flow defects” are known to the skilled person and defined for example in Rompp Lexikon, Lacke und Druckfarben, Georg Thieme Verlag 1998.

The term “comprising” in the sense of the present invention, in connection with the coating composition of the invention, for example, has in one preferred embodiment the meaning “consisting of”. In this preferred embodiment, as well as the components water, (A), (B), and (C), it is possible optionally for there to be (D) and/or (E) and/or organic solvents present in the coating composition of the invention. All components here may in each case be present in their below-mentioned, preferred embodiments in the coating composition of the invention.

The fractions in wt % of the components present in the coating composition of the invention, namely water, (A), (B), and (C), optionally also (D) and/or (E) and/or organic solvents, add up preferably to 100 wt %, based on the total weight of the coating composition.

### COATING COMPOSITION

The aqueous coating compositions of the invention comprise water as liquid diluent.

The term “aqueous” in connection with the coating composition of the invention refers preferably to liquid coating compositions which comprise as their liquid diluent, i.e., as the liquid solvent and/or dispersion medium, water as principal component. The aqueous coating compositions of the invention are therefore preferably substantially free from organic solvents. Optionally, however, the coating compositions of the invention may comprise organic solvents in said proportions. Examples of such organic solvents include heterocyclic, aliphatic or aromatic hydrocarbons, mono- or polyfunctional alcohols, ethers, esters, ketones, and amides, such as, for example, N-methylpyrrolidone, N-ethylpyrrolidone, dimethylformamide, toluene, xylene, butanol, ethyl glycol and butyl glycol and also their acetates, butyl diglycol, diethylene glycol dimethyl ether, cyclohexanone, methyl ethyl ketone, acetone, isophorone, or mixtures thereof. The fraction of these organic solvents is preferably at most 40.0 wt %, more preferably at most 35.0 wt %, very preferably at most 30.0 wt %, more particularly at most 25.0 wt %, based in each case on the total fraction of the liquid diluents—that is, liquid solvents and/or dispersion media—that are present in the coating composition of the invention. In this connection, the expression “substantially free from organic solvents” in connection with the coating composition of the invention means accordingly, preferably, that the fraction of organic solvents is at most 40.0 wt %, more preferably at most 35.0 wt %, very preferably at most 30.0 wt %, more particularly at most 25.0 wt %, based in each case on the total fraction of the liquid diluents—that is, liquid solvents and/or dispersion media—that are present in the coating composition of the invention. In particular, the expression “substantially free from organic solvents” in connection with the coating composition of the invention means that the fraction of organic solvents therein is at most in a range from 10.0 wt % to 35.0 wt %, based on the total fraction of the liquid diluents—that is, liquid solvents and/or dispersion media—that are present in the coating composition of the invention. The coating composition of the invention preferably comprises at most 25 wt %, more preferably at most 20 wt %, of organic solvent or of organic solvents, based on the total weight of the coating composition.

The coating composition of the invention is preferably a basecoat composition, i.e., a coating composition which is suitable for producing a basecoat film. The term “basecoat” is known to the skilled person and defined for example in Römpp Lexikon, Lacke und Druckfarben, Georg Thieme Verlag 1998.

The coating composition of the invention preferably has a solids fraction, i.e., a solids content, in the range from 10 to 50 wt %, more preferably in the range from 15 to 45 wt %, very preferably in the range from 15 to 50 wt %, based on the total weight of the coating composition. The skilled person is aware of methods for determining the solids fraction or solids content, i.e., the nonvolatile fraction. The nonvolatile fraction is determined in accordance with the method of determation described hereinafter.

### Binder (A)

The binder (A) used in the aqueous coating composition of the invention is preferably a binder which is dispersed or dissolved in water.

The term “binder” refers in the sense of the present invention, in accordance with DIN EN ISO 4618 (German version, date: March 2007) preferably to those nonvolatile fractions of a coating composition that are responsible for film formation, with the exception of pigments (B) and any fillers present therein, more particularly to the polymeric resins that are responsible for film formation. The nonvolatile fraction may be determined in accordance with the method described below. The concept of the binder (A) consequently incorporates not only the polymeric resins (A1) but also, preferably, any crosslinking agents (A2) present in the respective coating composition. The thickener (C), however, is preferably not embraced by the concept of the binder (A).

Suitable polymeric resins (A1) are all customary polymeric resins (A1) known to the skilled person, such as self-crosslinking and nonself-crosslinking polymeric resins (A1). If nonself-crosslinking polymeric resins (A1) are used, the binder (A) used in accordance with the invention may further comprise a crosslinking agent (A2). Suitable polymeric resins (A1) including crosslinking agents (A2) present optionally are known from, for example, EP 3 247 755 B1, EP 3 229 976 B1, WO 2014033135 A1, EP 0 228 003 A1, DE 44 38 504 A1, EP 0 593 454 B1, DE 199 48 004 A1, EP 0 787 159 B1, DE 40 09 858 A1, DE 44 37 535 A1, and WO 2005/021168 A1, more particularly from EP 3 247 755 B1, EP 3 229 976 B1, WO 2014033135 A1, EP 0 228 003 A1, DE 199 48 004 A1, DE 40 09 858 A1, and DE 44 37 535 A1.

The binder (A) preferably comprises at least one polymeric resin (A1), which optionally has reactive functional groups which permit a crosslinking reaction.

The polymeric resin (A1) in the binder (A1) used in accordance with the invention preferably has crosslinkable reactive functional groups. Any customary crosslinkable reactive functional group known to the skilled person is suitable in this context. The at least one polymeric resin in the binder (A) preferably has at least one kind of functional reactive groups selected from the group consisting of primary amino groups, secondary amino groups, hydroxyl groups, thiol groups, carboxyl groups, groups which have at least one C═C double bond, such as vinyl groups or (meth)acrylate groups, for example, and epoxide groups. The polymeric resin (A1) in the binder (A) preferably has functional hydroxyl groups.

For the purposes of the present invention, the expression “(meth)acrylic” or “(meth)acrylate” embraces in each case the definitions “methacrylic” and/or “acrylic” and “methacrylate” and/or “acrylate”, respectively.

Where the polymeric resin (A1) in the binder (A) has crosslinkable functional groups such as hydroxyl groups, the fraction of crosslinkable functional groups such as hydroxyl groups is preferably in the range from 0.1 wt % to 7.0 wt %, more preferably from 0.25 to 6.5 wt %, very preferably from 0.50 to 6.0 wt %, more particularly from 0.75 to 5.5 wt %, based in each case on the total weight of the solids content of the polymeric resin (A1) in the binder (A).

The polymeric resin (A1) and the optionally present crosslinking agent (A2) are curable or crosslinkable exothermically or endothermically. The polymeric resin (A1) and the optionally present crosslinking agent (A2) are more particularly curable or crosslinkable thermally. The polymeric resin (A1) and the optionally present crosslinking agent (A2) are preferably curable or crosslinkable in a temperature range from −20° C. up to 250° C. The polymeric resin (A1) and the optionally present crosslinking agent (A2) are preferably crosslinkable at room temperature or at temperatures in the range from 15° C. to 80° C. Room temperature for the purposes of the present invention means preferably a temperature in the range from 18° C. to 23° C. Alternatively the polymeric resin (A1) and the optionally present crosslinking agent (A2) are crosslinkable only at higher temperatures, as for example at temperatures≥80° C., more preferably ≥110° C., very preferably ≥140° C. or ≥150° C. With particular advantage the polymeric resin (A1) and the optionally present crosslinking agent (A2) are crosslinkable at 50 to 150° C., more preferably at 70 to 150° C., and very preferably at 80 to 150° C.

The binder (A) preferably comprises at least one polymeric resin (A1) selected from the group consisting of polyurethanes, polyesters, polyamides, polyureas, polystyrenes, polycarbonates, poly(meth)acrylates, vinyl ester-based resins, epoxy resins, phenyl-formaldehyde resins, melamine-formaldehyde resins, phenolic resins, and silicone resins, and also mixtures thereof, with preferably 70 to 100 wt % of the polymeric resin being selected from at least one of the aforementioned polymers. Among the stated polymers, the reference is preferably in each case both to homopolymers and to copolymers. These resins and also their preparation are known to the skilled person. Polyesters which are suitable are known from DE 40 09 858 A1, for example. Suitable polyurethanes are known from DE 199 48 004 A1 and from EP 0 228 003 A1, for example. The term “polyurethanes” preferably includes, in particular, polyurethane poly(meth)acrylates, i.e., polyurethane-modified poly(meth)acrylates. Such polyurethane poly(meth)acrylates are known to the skilled person from DE 44 37 535 A1 and EP 3 229 976 B1, for example.

The binder (A) preferably comprises at least one polymeric resin (A1) selected from the group consisting of polyurethanes, polyureas, polyesters, and poly(meth)acrylates, with preferably 70 to 100 wt % of the polymeric resin in the binder being selected from at least one of the aforementioned polymers.

Also possible is the presence in the binder (A) of two or more different polymeric resins (A1), as for example two or three polymeric resins (A1) different from one another in each case.

In one particularly preferred embodiment, the binder (A) comprises, as polymeric resin (A1), at least one polyurethane, with preferably 70 to 100 wt % of the polymeric resin constituting such a polyurethane, and/or, as polymeric resin (A1), at least one poly(meth)acrylate, with preferably 70 to 100 wt % of the polymeric resin being selected from such a poly(meth)acrylate, and/or, as polymeric resin (A1), at least one polyester, with preferably 70 to 100 wt % of the polymeric resin being selected from such a polyester.

The binder (A) may comprise a polymeric resin (A1) which is cured or crosslinked with participation of isocyanate groups and/or oligomerized or polymerized isocyanate groups, very preferably at least one corresponding polyurethane and/or polyester and/or poly(meth)acrylate.

Where the binder (A) comprises at least one polyurethane as polymeric resin (A1), particular suitability is possessed by polyurethane-based resins which are prepared by a polyaddition reaction between hydroxyl-containing compounds such as polyols, including diols (such as, for example, hydroxyl groups of hydroxyl-containing polyesters or hydroxyl-containing polyethers and also mixtures and copolymers thereof) and at least one isocyanate or polyisocyanate (including aromatic and aliphatic isocyanates, di-, tri- and/or polyisocyanates). Normally this needs a stochiometric conversion of the OH groups of the polyols with the isocyanate groups of the polyisocyanates. However, the stochiometric ratio to be used may also be varied, since the polyisocyanate can be added to the polyol component in amounts such that there may be an “overcrosslinking” or an “undercrosslinking”. Besides a reaction of isocyanate groups with OH groups, a further crosslinking reaction which may occur is, for example, the di- and trimerization of isocyanates (to form uretdiones or isocyanurates). Suitable polyisocyanates and isocyanates include all polyisocyanates and isocyanates, respectively, which can be employed and have been stated as crosslinking agents (A2).

Where the binder (A) comprises at least one polyurethane as polymeric resin (A1), it is suitably prepared using preferably a polyester polyol as prepolymer polyol component. Suitable polyester polyols include, in particular, compounds which derive from at least one polyol such as at least one diol, as for example ethylene glycol, propylene glycol (1,2-propanediol), trimethylene glycol (1,3-propanediol), neopentyl glycol, 1,4-butanediol and/or 1,6-hexanediol, or such as at least one triol such as 1,1,1-trimethylolpropane (TMP), and from at least one dicarboxylic acid such as, for example, adipic acid, terephthalic acid, isophthalic acid, ortho-phthalic acid and/or dimethylolpropionic acid and/or from at least one dicarboxylic acid derivative such as a dicarboxylic ester and/or a dicarboxylic anhydride such as phthalic anhydride. Especially preferred is a polyester polyol of this kind, used as prepolymer polyol component, which derives from at least one diol and/or triol selected from the group consisting of 1,6-hexanediol, neopentyl glycol, trimethylolpropane, and mixtures thereof, and from at least one dicarboxylic acid (or from at least one dicarboxylic acid derivative thereof) selected from the group consisting of adipic acid, terephthalic acid, isophthalic acid, ortho-phthalic acid, dimethylolpropionic acid, and mixtures thereof. Preference is given to using at least one such polyester polyol with at least one crosslinking agent (A2), more particularly with at least one polyisocyanate such as HDI or IPDI, for preparing the polyurethane resin which is encompassed by the binder (A).

In order to permit a solution or dispersion of a polyurethane resin and/or polyurea resin of this kind in water, it is usual to incorporate ionic and/or hydrophilic segments into the polyurethane and/or polyurea chain in order to stabilize the dispersion. Soft segments used in the case of polyurethanes may preferably be 20 to 100 mol % of relatively high molecular mass diols, based on the amount of all diols, preferably polyester diols, having a number-average molecular weight Mn of 500 to 5000 g/mol, preferably of 1000 to 3000 g/mol. The number-average molecular weight is determined by the method described hereinafter.

Where the binder (A) comprises at least one poly(meth)acrylate-based polymeric resin, it is suitably prepared with, in particular, monomer mixtures or oligomer mixtures of esters such as C₁₋₆ alkyl esters of acrylic acid and/or of methacrylic acid. Polymer synthesis is accomplished via the reaction of the C═C double bonds of these monomers. The preparation of such poly(meth)acrylate-based resins may be accomplished by means of a radical polymerization, which is initiated, for example, by the decomposition of organic peroxides.

Where the binder (A), in addition to at least one polymeric resin (A1), further comprises at least one crosslinking agent (A2), suitability for such an agent is possessed by all customary crosslinking agents known to the skilled person, such as, for example, aminoplast resins, phenoplast resins, polyfunctional Mannich bases, melamine resins, benzoguanamine resins, beta-hydroxyalkylamides, tris(alkoxycarbonylamino) triazines, epoxides, free polyisocyanates and/or blocked polyisocyanates, especially blocked polyisocyanates, and also compounds having on average at least two groups capable of transesterification, examples being reaction products of malonic diesters and polyisocyanates, or of polyhydric alcohol esters and partial esters of malonic acid with monoisocyanates. A particularly preferred crosslinking agent is a blocked polyisocyanate. Where blocked polyisocyanates are selected as crosslinking agents, the aqueous coating composition of the invention is formulated preferably as a one-component composition (1-K). Where nonblocked polyisocyanates are selected as crosslinking agents, the aqueous coating composition of the invention is formulated preferably as a two-component composition (2-K).

Employable with particular preference as crosslinking agents (A2) are melamine resins that are dispersible or soluble in water, preferably melamine-formaldehyde condensation products, more particularly etherified melamine-formaldehyde condensation products. The solubility or dispersibility in water of these products is dependent not only on the degree of condensation-which is to be as low as possible—but also on the etherifying component, with only the lowest members in the alkanol or ethylene glycol monoether series producing water-soluble condensates. The greatest significance is possessed by methanol-etherified(methylated) melamine resins. When solubilizers are used as optional further additives, it is also possible for ethanol-, propanol- and/or butanol-etherified melamine resins, more particularly the corresponding etherified melamine-formaldehyde condensation products, to be dissolved or dispersed in aqueous phase.

Isocyanates used are preferably (hetero) aliphatic, (hetero)cycloaliphatic, (hetero) aromatic, or (hetero) aliphatic-(hetero) aromatic isocyanates. Preferred are diisocyanates which contain 2 to 36, more particularly 6 to 15, carbon atoms. Preferred examples are 1,2-ethylene diisocyanate, 1,4-tetramethylene diisocyanate, 1,6-hexamethylene diisocyanate (HDI), 2,2,4-(2,4,4)-trimethyl-1,6-hexamethylene diisocyanate (TMDI), diphenylmethane diisocyanate (MDI), 1,9-diisocyanato-5-methylnonane, 1,8-diisocyanato-2,4-dimethyloctane, 1,12-dodecane diisocyanate, ω,ω′-diisocyanatodipropyl ether, cyclobutene 1,3-diisocyanate, cyclohexane 1,3-and-1,4-diisocyanate, 3-isocyanatomethyl-3,5,5-trimethyl-cyclohexyl isocyanate (isophorone diisocyanate, IPDI), 1,4-diisocyanatomethyl-2,3,5,6-tetramethylcyclohexane, decahydro-8-methyl (1,4-methanonaphthalene-2 (or 3), 5-ylenedimethylene diisocyanate, hexahydro-4,7-methanoindane-1 (or 2), 5 (or 6) ylenedimethylene diisocyanate, hexahydro-4,7-methanoindane-1 (or 2), 5 (or 6) ylene diisocyanate, 2,4- and/or 2,6-hexahydrotoluylene diisocyanate (H₆-TDI), 2,4- and/or 2,6-toluene diisocyanate (TDI), perhydro-2,4′-diphenylmethane diisocyanate, perhydro-4,4′-diphenylmethane diisocyanate (H₁₂MDI), 4,4′-diisocyanato-3,3′,5,5′-tetramethyldicyclohexylmethane, 4,4′-diisocyanato-2,2′,3,3′,5,5′,6,6′-octamethyldicyclohexylmethane, ω,ω′-diisocyanato-1,4-diethylbenzene, 1,4-diisocyanatomethyl-2,3,5,6-tetramethylbenzene, 2-methyl-1,5-diisocyanatopentane (MPDI), 2-ethyl-1,4-diisocyanatobutane, 1,10-diisocyanatodecane, 1,5-diisocyanatohexane, 1,3-diisocyanatomethylcyclohexane, 1,4-diisocyanatomethylcyclohexane, tetramethylxylylene diisocyanate (TMXDI), 2,5 (2,6)-bis(isocyanatomethyl) bicyclo[2.2.1] heptane (NBDI), and also any mixture of these compounds. Polyisocyanates of higher isocyanate functionality may also be used. Examples of such are trimerized hexamethylene diisocyanate and trimerized isophorone diisocyanate. Furthermore mixtures of polyisocyanates can also be utilized. The organic polyisocyanates suitable as crosslinking agents (A2) for the invention may also be prepolymers, deriving for example, from a polyol, including a polyether polyol or a polyester polyol. Utilized as blocked polyisocyanates may be any desired isocyanates wherein the isocyanate groups have been reacted with a compound, making the resultant blocked polyisocyanate particularly stable with respect to hydroxyl groups and amino groups such as primary and/or secondary amino groups at room temperature, in other words at a temperature of 18 to 23° C., but reacting at elevated temperatures, as for example at ≥80° C., more preferably ≥110° C., very preferably ≥130° C., and especially preferably ≥140° C., or at 90° C. to 300° C., or at 100 to 250° C., more preferably still at 125 to 250° C., and very preferably at 150 to 250°. For the blocking of the isocyanates it is possible with preference to use any desired suitable aliphatic, cycloaliphatic, or aromatic alkyl monoalcohols. Examples are the aliphatic alcohols, such as methyl, ethyl, chloroethyl, propyl, butyl, amyl, hexyl, heptyl, octyl, nonyl, 3,3,5-trimethylhexyl, decyl, and lauryl alcohol; cycloaliphatic alcohols, such as cyclopentanol and cyclohexanol; and aromatic alkyl alcohols, such as phenylcarbinol and methylphenylcarbinol. Other suitable blocking agents are hydroxylamines, such as ethanolamine, oximes, such as methyl ethyl ketone oxime, acetone oxime, and cyclohexanone oxime, and amines, such as dibutylamine and diisopropylamine.

The aqueous coating composition of the invention preferably comprises as crosslinking agent (A2) at least one optionally alkylated melamine-formaldehyde condensation product.

The crosslinking agent (A2) is preferably a crosslinking agent in dispersion or solution in water. To accelerate the crosslinking it is possible for suitable catalysts to be added to the aqueous coating composition. The skilled person also knows of such catalysts.

The aqueous coating composition of the invention preferably has a solids content, in terms of the at least one binder (A), in a range from 10 to 60 wt %, more preferably from 15 to 40 wt %, very preferably from 20 to 35 wt %, based in each case on the total weight of the aqueous coating composition.

The aqueous coating composition of the invention preferably comprises the crosslinking agent (A2) in an amount from 5 to 40 wt %, preferably in an amount from 10 to 35 wt %, more preferably in an amount from 15 to 30 wt %, based on the total weight of the polymeric resins (A1) in the coating composition. These quantity figures are based in each case on the respective solids content.

### Pigment (B)

The coating composition of the invention comprises at least one pigment (B).

The pigment (B) is preferably in the form of a pigment (B) in dispersion or solution in water.

Particularly suitable as pigment (B) are organic and/or inorganic, coloring and/or extending pigments, and more particularly pigments which have preferably at least two of these properties.

In one embodiment, the at least one pigment (B) is an effect pigment or a mixture of at least one effect pigment and at least one pigment different therefrom which is not itself an effect pigment and which is selected preferably from the group consisting of organic and inorganic, coloring and extending pigments, and pigments which have preferably at least two of these properties.

A skilled person is familiar with the concept of effect pigments. A corresponding definition is found in, for example, Rompp Lexikon Lacke und Druckfarben, Georg Thieme Verlag, 1998. Effect pigments are preferably pigments which impart optical effect or color and optical effect, more particularly optical effect. A corresponding classification of the pigments is made according to DIN 55945 (Date: December 2011).

The pigment (B) may be selected from the group consisting of optionally coated organic or inorganic effect pigments like from the group consisting of optionally coated metallic effect pigments, optionally coated metal oxide effect pigments, optionally coated effect pigments composed of metals and nonmetals, and optionally coated nonmetallic effect pigments.

Explicit examples are silicate-coated metallic effect pigments, and optionally coated nonmetallic effect pigments such as pearlescent pigments, more particularly mica pigments. With more preference the pigment (B) is selected from the group consisting of metallic effect pigments and silicate-coated metallic effect pigments.

Examples of metallic effect pigments are aluminum effect pigments, iron effect pigments, or copper effect pigments. Preferred are optionally coated-such as, for example, silanized and/or chromated-aluminum effect pigments, more particularly commercially available products from Eckart such as Stapa® Hydrolac, Stapa® Hydroxal, Stapa® Hydrolux and Stapa® Hydrolan, most preferably Stapa® Hydrolux and Stapa® Hydrolan.

The effect pigments (B) used in accordance with the invention may be in any customary form known to the skilled person, such as a leaflet form and/or a platelet form, for example, more particularly a (corn) flake form or a silver dollar form.

Examples of effect pigments composed of metals and nonmetals are aluminum pigments coated with iron oxide, as described in European patent application EP 0 562 329 A2, for example, glass leaflets coated with metals, more particularly with aluminum, or interference pigments which include a reflector layer made of metal, more particularly aluminum.

Examples of nonmetallic effect pigments are pearlescent pigments, more particularly mica pigments, graphite pigments which are coated with metal oxides and have a platelet form, for example, interference pigments which do not include a metal reflector layer and which exhibit a strong color flop, effect pigments based on iron oxide, or organic, liquid-crystalline effect pigments.

For further details regarding the effect pigments employed preferably in accordance with the invention as pigment (B), refer to Rompp Lexikon Lacke und Druckfarben, Georg Thieme Verlag, 1998, pages 176, “Effect pigments” and pages 380 and 381, “metal oxide-mica pigments” to “metal pigments”. Pigments suitable as pigment (B) that are not effect pigments may be selected from the group consisting of organic and inorganic, coloring and extending pigments, pigments which have preferably at least two of these properties, and nanoparticles. Examples of suitable inorganic coloring pigments are white pigments such as titanium dioxide, zinc white, zinc sulfide or lithopone; black pigments such as carbon black, iron manganese black, or spinel black; chromatic pigments such as chromium oxide, chromium oxide hydrate green, cobalt green or ultramarine green, cobalt blue, ultramarine blue or manganese blue, ultramarine violet or cobalt violet and manganese violet, red iron oxide, cadmium sulfoselenide, molybdate red or ultramarine red; brown iron oxide, mixed brown, spinel phases and corundum phases or chromium orange; or yellow iron oxide, nickel titanium yellow, chromium titanium yellow, cadmium sulfide, cadmium zinc sulfide, chromium yellow or bismuth vanadate. Examples of suitable organic coloring pigments are monoazo pigments, disazo pigments, anthraquinone pigments, benzimidazole pigments, quinoacridone pigments, quinophthalone pigments, diketopyrrolopyrrol pigments, dioxazine pigments, indanthrone pigments, isoindoline pigments, isoindolinone pigments, azomethine pigments, thioindigo pigments, metal complex pigments, perinone pigments, perylene pigments, phthalocyanine pigments, or aniline black. Examples of suitable extending pigments or fillers are chalk, calcium sulfate, barium sulfate, silicates such as talc or kaolin, silicas, oxides such as aluminum hydroxide or magnesium hydroxide, or organic fillers such as textile fibers, cellulose fibers, polyethylene fibers, or polymer powders; for further details, refer to Römpp Lexikon Lacke und Druckfarben, Georg Thieme Verlag, 1998, pages 250 ff., “fillers”. The nanoparticles are preferably selected from the group consisting of main and transition group metals and their compounds. The main and transition group metals are preferably selected from metals from main groups three to five, from transition groups three to six and also one and two, of the Periodic Table of the Elements, and also from the lanthanides. Particularly preferred for use are boron, aluminum, gallium, silicon, germanium, tin, arsenic, antimony, silver, zinc, titanium, zirconium, hafnium, vanadium, niobium, tantalum, molybdenum, tungsten, and cerium, more particularly aluminum, silicon, silver, cerium, titanium, and zirconium. The compounds of the metals are preferably the oxides, oxide hydrates, sulfates, or phosphates. Preference is given to using silver, silicon dioxide, aluminum oxide, aluminum oxide hydrate, titanium dioxide, zirconium oxide, cerium oxide, and mixtures thereof, more preferably silver, cerium oxide, silicon dioxide, aluminum oxide hydrate and mixtures thereof, very preferably aluminum oxide hydrate, and more particularly boehmite. These nanoparticles preferably have an average primary particle size <50 nm, more preferably 5 to 50 nm, especially 10 to 30 nm. The primary particle size here is determined preferably by means of laser diffraction, more preferably by means of laser granulometry in accordance with ISO 13320-1 (Date: September 2009).

The amount of the inventively employed pigment (B) in the coating composition of the invention may vary very widely according to the inventive use of the pigmented coating composition in question. The amount of pigment (B), based on the coating composition of the invention, is preferably 0.1 to 80 wt %, more preferably 0.5 to 70 wt %, very preferably 1.0 to 60 wt %, especially preferably 1.5 to 50 wt %, and more particularly 2.0 to 40 wt %.

### Thickener (C)

The coating composition of the invention comprises at least one thickener (C) which is an aqueous dispersion of a polyamide having a volume-based particle size distribution having an×10 quantile of at least 30 nm, an×50 quantile of at least 60 nm and an×90 quantile of at most 2000 nm. The thickener (C), therefore, is an aqueous dispersion of a specific polyamide, more particularly a polyamide constituted with a specific particle size distribution within the aqueous dispersion.

It surprisingly emerged that these specific polyamide dispersions including particles of specific particle size distribution provide the technical effects and solve the problems described in the introductory part. Specifically, the application of the above-described dispersions in aqueous coating compositions provide technical advantages over aqueous coating compositions comprising standard polyamide dispersions as thickeners (or other polyamide thickeners not having the specific particle size distribution as defined above).

Preferably, the aqueous polyamide dispersion (C) has a volume-based particle size distribution having an×10 quantile of 30 to 120 nm, an×50 quantile of 60 to 300 nm and an×90 quantile of 200 to 2000 nm. Even more preferably, the ranges are as follows: ×10 quantile of 50 to 90 nm, ×50 quantile of 100 to 250 nm and an×90 quantile of at most 1000 nm or even ×10 quantile of 60 to 80 nm, ×50 quantile of 100 to 200 nm and an×90 quantile of 300 to 550 nm.

Polyamides and their production are generally well-known to the person skilled in the art. For example, their production may include reacting at least one polycarboxylic acid, preferably at least one polycarboxylic acid selected from the group consisting of aliphatic C₃-C₂₂ dicarboxylic acids, polymers such as dimers and trimers of aliphatic C₁₄-C₂₂ monocarboxylic acids, like dimeric fatty acids, and mixtures thereof, with at least one polyamine, preferably with at least one aliphatic C₂-C₁₂ diamine, where the reaction product obtained by step is optionally contacted subsequently with at least one preferably basic neutralizing agent. More details on polyamides and respective educts for their production are found below.

Also, generally, production of aqueous dispersions of polyamides are well-known. For example, it is known to include a polyamide into an aqueous dispersion in form of a melt, for example after increasing its temperature to for example 80 to 140° C., via batch procedures, i.e. either by provision of such a melt of polyamides and successive (for example drop-by-drop) addition of water or successive addition of the polyamide to an respective aqueous phase. Obviously, such production may also include application of known additives like, for example, emulsifiers or dispersants to facilitate formation of such a dispersion.

It has been emerged that production of specific aqueous dispersions of polyamides as to be applied according to the present application works particularly well when conducted as continuous production, more particularly as continuous jet production, i.e. a continuous production in which
(i) jet streams of water and fluid (for example liquidized, like melted) polyamide are continuously led into a reactor via an inlet into the reactor,
(ii) the jet streams and thus water and polyamide are continuously dispersed within the reactor, and
(iii) the thus produced aqueous dispersion continuously exits the reactor via an outlet of the reactor, to result in a respective aqueous polyamide dispersion.

The jet streams can be operated and adjusted according to individual needs, for example via conventional pumps like gear pumps or piston pumps.

Preferably, water and polyamide are heated to a temperature of above 100° C., meaning that also the formation of the dispersion in the jet reactor takes place at such elevated temperature.

Within the context of the present invention, it is important that the polyamide is comprised in the inventive coating composition in form a specific aqueous dispersion as outlined above. Thereby, the aqueous dispersion may be directly applied in the composition. Also, the aqueous dispersion may be applied via an intermediate (i.e. the aqueous dispersion of polyamide is included into an intermediate, for example a certain premixture or slurry, which then is applied during production of the coating composition).

The coating composition of the invention comprises at least one aqueous dispersion of at least one thickener (C) which is an aqueous polyamide dispersion having a volume-based particle size distribution having an×10 quantile of at least 30 nm, an×50 quantile of at least 60 nm and an×90 quantile of at most 2000 nm. The thickener (C), therefore, is an aqueous dispersion of a specific polyamide, more particularly a polyamide constituted with a specific particle size distribution within the aqueous dispersion.

The coating composition of the invention preferably has a solids content, in terms of the at least one polyamide of the dispersion, in a range from 0.1 to 10 wt %, more preferably from 0.2 to 7.5 wt %, very preferably from 0.3 to 5 wt %, more particularly from 1.0 to 9.0 wt %, based in each case on the total weight of the coating composition.

### Polyamide

The polyamide that is used is obtainable preferably by reaction of at least one polycarboxylic acid (C1a) of at least one polyamine (C1b).

The term “polycarboxylic acid” refers in the sense of the present invention preferably also to corresponding polycarboxylic acid derivatives which can be used for preparing the polyamide, examples being corresponding polycarboxylic esters and/or polycarboxylic anhydrides.

The term “polycarboxylic acid” (C1a) for the purposes of the present invention encompasses preferably a carboxylic acid which has two or more carboxyl groups, as for example 2, 3, 4, 5, or 6 carboxyl groups. Polycarboxylic acid more preferably has 2 or 3 carboxyl groups. Polycarboxylic acids with two carboxyl groups are dicarboxylic acids, and polycarboxylic acids with three carboxyl groups are tricarboxylic acids. The inventively employed polycarboxylic acids (C1a) may be aromatic, semiaromatic, cycloaliphatic, semicycloaliphatic, or aliphatic, preferably aliphatic. The inventively employed polycarboxylic acids (C1a) preferably have 4 to 66 carbon atoms per molecule.

With particular preference the polycarboxylic acid (C1a) used in preparing the inventively employed polyamide (C1) is selected from the group consisting of aliphatic C₃-C₂₂ dicarboxylic acids, polymers, more particularly dimers and trimers, of aliphatic C₁₄-C₂₂ monocarboxylic acids, and mixtures thereof. Very preferably, the polycarboxylic acid (C1a) used in preparing the inventively employed polyamide (C1) is selected from the group consisting of aliphatic C₃-C₂₂ dicarboxylic acids, dimers of aliphatic C₁₄-C₂₂ monocarboxylic acids, and mixtures thereof.

The term “aliphatic C₃-C₂₂ dicarboxylic acid” refers in the sense of the present invention preferably to a saturated or unsaturated, preferably saturated, aliphatic C₃-C₂₂ dicarboxylic acid having a total of 3-22, i.e., 3, 4, 5, 6, 7, 8, 9, 10, 11, 12, 13, 14, 15, 16, 17, 18, 19, 20, 21, or 22 carbon atoms, preferably an aliphatic C₃-C₂₀ dicarboxylic acid having a total of 3 to 20, i.e., 3, 4, 5, 6, 7, 8, 9, 10, 11, 12, 13, 14, 15, 16, 17, 18, 19, or 20 carbon atoms, having in each case precisely two-C(═O)—OH groups, i.e., for example, an aliphatic C₃-C₂₂ dicarboxylic acid which as well as these two —C(═O)—OH groups has a C₁-C₂₀ aliphatic radical having a total of 1 to 20 carbon atoms. The expression “aliphatic” here encompasses preferably acyclic saturated or unsaturated, preferably unsaturated, branched or unbranched aliphatic radicals. To the skilled person it is clear that an unsaturated bond within the C₃-C₂₂ dicarboxylic acid is possible only for C₄-C₂₂ dicarboxylic acids. Unsaturated aliphatic radicals in this context have at least one, preferably 1, 2, 3, 4, or 5, more preferably 1, 2, 3, or 4, very preferably 1, 2, or 3 carbon double bond(s). The aliphatic C₃-C₂₂ dicarboxylic acids may be natural or synthesized dicarboxylic acids. The aliphatic C₃-C₂₂ dicarboxylic acids may optionally be substituted one or more times, as for example two, three, four, or five times, preferably by at least one substituent selected from the group consisting of OH, O—C₁₋₄ aliphatic radicals, ═O, NH₂, NH(C₁₋₄ aliphatic radicals), N(C₁₄ aliphatic radicals), it being possible for substitution to be on the same or on different carbon atoms. Preference is given to aliphatic C₃-C₂₂ dicarboxylic acids selected from the group consisting of malonic acid, succinic acid, glutaric acid, adipic acid, pimelic acid, suberic acid, azelaic acid, sebacic acid, undecanedicarboxylic acid, dodecanedicarboxylic acid, tridecanedicarboxylic acid, tetradecanedicarboxylic acid, and hexadecanedicarboxylic acid.

The term “aliphatic C₁₄-C₂₂ monocarboxylic acid” is understood in the sense of the present invention to refer preferably to a saturated or unsaturated, preferably unsaturated, aliphatic C₁₄-C₂₂ monocarboxylic acid having a total of 14-22, i.e., 14, 15, 16, 17, 18, 19, 20, 21, or 22 carbon atoms, preferably an aliphatic C₁₆-C₂₀ monocarboxylic acid having a total of 16-20, i.e., 16, 17, 18, 19, or 20 carbon atoms, having in each case exactly one —C(═O)—OH group, i.e., an aliphatic C₁₄-C₂₂ monocarboxylic acid which as well as this one —C(═O)—OH group has a C₁₃-C₂₁ aliphatic radical having a total of 13-21, i.e., 13, 14, 15, 16, 17, 18, 19, 20, or 21 carbon atoms, preferably a C₁₅-C₁₉ aliphatic radical having a total of 15-19, i.e., 15, 16, 17, 18, or 19 carbon atoms. The expression “aliphatic” here encompasses preferably acyclic saturated or unsaturated, preferably unsaturated, branched or unbranched aliphatic radicals. Unsaturated aliphatic radicals here have at least one, preferably 1, 2, 3, 4, or 5, more preferably 1, 2, 3, or 4, very preferably 1, 2, or 3, carbon double bond(s). The aliphatic C₁₄-C₂₂ monocarboxylic acids may be natural or synthesized fatty acids. The aliphatic C₁₄-C₂₂ monocarboxylic acids may optionally be substituted one or more times, as for example two, three, four or five times, preferably by at least one substituent selected from the group consisting of OH, O—C₁₋₄ aliphatic radicals, ═O, NH₂, NH(C₁₋₄ aliphatic radicals), N(C₁₄ aliphatic radicals), it being possible for the substitution to be on the same or on different carbon atoms. Preference is given to aliphatic C₁₄-C₂₂ monocarboxylic acids selected from the group consisting of myristic acid, pentadecanoic acid, palmitic acid, margaric acid, stearic acid, nonadecanoic acid, arachidic acid, henicosanoic acid, docosanoic acid, myristoleic acid, palmitoleic acid, petroselinic acid, oleic acid, elaideic acid, vaccenic acid, gadoleic acid, icosenoic acid, cetoleic acid, erucic acid, linoleic acid, linolenic acid, calendulic acid, punicic acid, elaeostearic acid, arachidonic acid, timnodonic acid, clupanodonic acid, and cervonic acid. Preference is given to aliphatic C₁₆-C₂₀ monocarboxylic acids selected from the group consisting of palmitic acid, margaric acid, stearic acid, nonadecanoic acid, arachidic acid, palmitoleic acid, petroselinic acid, oleic acid, elaidic acid, vaccenic acid, gadoleic acid, icosenoic acid, linoleic acid, linolenic acid, calendulic acid, punicic acid, elaeostearic acid, arachidonic acid, and timnodonic acid. Preference is given to aliphatic C₁₈ monocarboxylic acids selected from the group consisting of stearic acid, petroselinic acid, oleic acid, elaidic acid, vaccenic acid, linoleic acid, linolenic acid, calendulic acid, punicic acid, and elaeostearic acid, more particularly selected from the group consisting of stearic acid, oleic acid, linolic acid, and linolenic acid, most preferably selected from the group consisting of oleic acid, linoleic acid, and linolenic acid.

Known to the skilled person are preparation processes for providing polymers, more particularly dimers and trimers, of aliphatic C₁₄-C₂₂ monocarboxylic acids, i.e., for providing polymerized aliphatic C₁₄-C₂₂ monocarboxylic acids, such as, for example, dimerized, trimerized, and more highly polymerized aliphatic C₁₄-C₂₂ monocarboxylic acids, from DE 25 06 211 A1, U.S. Pat. No. 2,793,219 A, 2,955,121 A, for example. The polymerized aliphatic C₁₄-C₂₂ monocarboxylic acids may optionally be substituted one or more times, as for example two, three, four, or five times, preferably by at least one substituent selected from the group consisting of OH, O—C₁₄ aliphatic radicals, ═O, NH₂, NH(C₁₋₄ aliphatic radicals), N(C₁₋₄ aliphatic radicals), it being possible for the substitution to be on the same or on different carbon atoms. Starting material used for preparing such polymerized aliphatic C₁₄-C₂₂ monocarboxylic acids are at least monounsaturated aliphatic C₁₄-C₂₂ monocarboxylic acids. The polymerized, such as dimerized and trimerized, aliphatic C₁₄-C₂₂ monocarboxylic acids obtained may in each case be separated by distillation from one another and also from higher polyvalent polymerization products, and may be subjected, optionally, to further conversion reactions, such as hydrogenations, for example.

The term “polyamine” (C1b) in the sense of the present invention refers preferably to a compound which has at least two, preferably terminal, primary amino groups. In total, however, a polyamine may have up to and including 10 amino groups—that is, in addition to the at least two primary amino groups, it may also have up to and including 8 further amino groups, which are preferably primary or secondary amino groups. A “polyamine” in the sense of the present invention may be a (hetero) aliphatic, (hetero)cycloaliphatic, or (hetero) aromatic polyamine. The polyamine is preferably a diamine or triamine, more preferably a diamine. The inventively employed polyamines (C1b) preferably have 2 to 20, more preferably 2 to 12, carbon atoms per molecule. The polyamine may optionally be substituted one or more times, as for example two, three, four, or five times, preferably by at least one substituent selected from the group consisting of OH, O—C₁₄ aliphatic radicals, ═O, NH₂, NH(C₁₋₄ aliphatic radicals), N(C₁₄ aliphatic radicals), it being possible for the substitution to be on the same or on different carbon atoms.

Very preferably, the polyamine (C1b) used to prepare the polyamide (C₁) employed inventively is selected from the group consisting of aliphatic C₂-C₂₀ diamines. Very preferably, the polyamine (C1b) used to prepare the polyamide (C₁) employed inventively is selected from the group consisting of aliphatic C₂-C₁₂ diamines.

The term “aliphatic C₂-C₂₀ diamine” refers in the sense of the present invention preferably to a saturated or unsaturated, preferably a saturated, aliphatic C₂-C₂₀ diamine having a total of 2-20, i.e., 2, 3, 4, 5, 6, 7, 8, 9, 10, 11, 12, 13, 14, 15, 16, 17, 18, 19, or 20, carbon atoms, preferably an aliphatic C₂-C₁₂ diamine having a total of 2-12, i.e., 2, 3, 4, 5, 6, 7, 8, 9, 10, 11, or 12, carbon atoms, and having in each case precisely two, preferably terminal, —NH₂ groups. The expression “aliphatic” here encompasses preferably acyclic saturated or unsaturated, preferably saturated, branched or unbranched aliphatic radicals. Unsaturated aliphatic radicals in this context have at least one, preferably 1, 2, 3, 4, or 5, more preferably 1, 2, 3, or 4, very preferably 1, 2, or 3 carbon double bond(s). The aliphatic C₂-C₂₀ diamine may optionally be substituted one or more times, as for example two, three, four, or five times, preferably by at least one substituent selected from the group consisting of OH, O—C₁₄ aliphatic radicals, ═O, NH₂, NH(C₁₋₄ aliphatic radicals), N(C₁₄ aliphatic radicals), it being possible for the substitution to be on the same or on different carbon atoms. The aliphatic C₂-C₂₀ diamines are preferably selected from the group consisting of ethylenediamine, 1,3-diaminopropane, 1,4-diaminobutane, 1,5-diaminopentane, 1,6-diaminohexane (hexamethylenediamine), 1,7-diaminoheptane, 1,8-diaminoctane (octamethylenediamine), 1,9 diaminononane, 1,10-diaminodecane, 1,11-diaminoundecane, and 1,12-diaminododecane.

The polyamide is preferably obtainable by reaction of at least one polycarboxylic acid (C1a) selected from the group consisting of aliphatic C₃-C₂₂ dicarboxylic acids, polymers such as dimers and trimers of aliphatic C₁₄-C₂₂ monocarboxylic acids, and mixtures thereof, with at least one aliphatic C₂-C₁₂ diamine (C1b).

The reaction of at least one polycarboxylic acid (C1a) and at least one polyamine (C1b) is carried out preferably in a solvent, which is preferably an organic solvent. The polyamide is preferably prepared using, per amino group of the polyamine used as component (C1b), more particularly of the aliphatic C₂-C₁₂ diamine, at least 1.0 mol, more preferably at least 1.1 mol, very preferably at least 1.2 mol or at least 1.4 mol, of polycarboxylic acid (C1a), more particularly of polycarboxylic acid (C1a) selected from the group consisting of aliphatic C₃-C₂₂ dicarboxylic acids and dimers of aliphatic C₁₄-C₂₂ monocarboxylic acids.

Where, for example, 1 mol of an aliphatic C₂-C₁₂ diamine is used as component (C1b), in this case at least 1.0 mol, more preferably at least 1.1 mol, very preferably at least 1.2 mol or at least 1.4 mol, of polycarboxylic acid (C1a) selected from the group consisting of aliphatic C₃-C₂₂ dicarboxylic acids and dimers of aliphatic C₁₄-C₂₂ monocarboxylic acids is used for preparing the polyamide.

The polyamide preferably has an acid number in the range from 1 to 200 mg, more preferably from 20 to 120 mg, very preferably from 30 to 100 mg of KOH per g of polyamide. The skilled person is aware of methods for determining the acid number. The acid number is determined preferably to DIN EN ISO 2114 (date: June 2002).

The acid number of the inventively employed polyamides may be controlled and adjusted in particular by contacting and reacting the polyamide obtained after the reaction, with at least one neutralizing agent, preferably via the amount of neutralizing agent used. Corresponding suitable, preferably basic, neutralizing agents are known to the skilled person. One preferred neutralizing agent is an amino alcohol, suitability being possessed with particular preference by dimethylethanolamine (DMEA).

The polyamide is preferably obtainable by a method comprising at least the following step, namely:
by reacting at least one polycarboxylic acid (C1a), preferably at least one polycarboxylic acid selected from the group consisting of aliphatic C₃-C₂₂ dicarboxylic acids, polymers such as dimers and trimers of aliphatic C₁₄-C₂₂ monocarboxylic acids, and mixtures thereof, with at least one polyamine (C1b), preferably with at least one aliphatic C₂-C₁₂ diamine (C1b),

where the reaction product obtained by this step is optionally contacted subsequently with at least one preferably basic neutralizing agent. The acid number of the reaction product obtained by this step may be adjusted or reduced by reaction of free carboxyl groups with the neutralizing agent. The at least one neutralizing agent is used preferably in an amount such that 60 to 90 mol %, more preferably 70 to 90 mol % or 75 to 85 mol %, of the free carboxyl groups are neutralized.

The inventively employed polyamide preferably has a melting point in the range from 50 to 120° C., more preferably in a range of from 55° C. to 100° C.

### Further Thickener (D)

The coating composition of the invention may optionally comprise at least one further thickener (D), different from component (C), such as, for example, at least one thickener (D) selected from the group consisting of metal silicates, thickeners based on poly(meth)acrylic acid, thickeners based on polyurethanes, polymeric waxes, and mixtures thereof.

The metal silicate is selected preferably from the group of the smectites. With particular preference the smectites are selected from the group of montmorillonites and hectorites. The montmorillonites and hectorites are selected more particularly from the group consisting of aluminum magnesium silicates and also sodium magnesium and sodium magnesium fluorine lithium phyllosilicates. These inorganic phyllosilicates are sold under the brand name Laponite®. Thickeners based on poly(meth)acrylic acid are optionally crosslinked and/or neutralized with a suitable base. Examples of such thickeners based on poly(meth)acrylic i Swellable Emulsions” (ASE), and hydrophobically modified variants of these, the “Hydrophilically modified Alkali Swellable Emulsions” (HASE). Thickeners based on poly(meth)acrylic acid are preferably anionic. Corresponding products such as Rheovis® AS 1130 are available commercially.

Thickeners based on polyurethanes are optionally crosslinked and/or neutralized with a suitable base. Corresponding products such as Rheovis® PU 1250 are available commercially. Where at least one polyurethane is used as polymer (C₂), the polyurethane-based thickener is preferably different from this polymer (C₂). Where at least one polyurethane is used as polymeric resin (A1), the polyurethane-based thickener is preferably different from this polymeric resin (A1).

Examples of suitable polymeric waxes include optionally modified polymeric waxes based on ethylene-vinyl acetate copolymers. Corresponding products are available commercially, for example, under the Aquatix® name.

Where the coating composition of the invention comprises at least one further thickener (D), the relative weight ratio of the thickener (C) in the coating composition of the invention to the further thickener (D) is preferably in the range from 100:1 to 1:1, more preferably from 80:1 to 1:1. All figures are based on the solids content of the components.

### Additive (E)

The coating composition of the invention, depending on its desired application, may comprise one or more customarily employed additives as component (E). These additives (E) are preferably selected from the group consisting of antioxidants, antistats, wetting agents, dispersants, emulsifiers, flow control assistants, solubilizers, defoaming agents, wetting agents, stabilizing agents, preferably heat stabilizers and/or thermal stabilizers, in-process stabilizers, and UV and/or light stabilizers, photoprotectants, deaerating agents, inhibitors, catalysts, waxes, wetting agents, dispersants, flexibilizing agents, flame retardants, reactive diluents, carrier media, resins, waxes, hydrophobizing agents, hydrophilizing agents, impact modifiers, expandants, process auxiliaries, plasticizers, and mixtures of the aforementioned further additives. The amount of additive (E) in the coating composition of the invention may vary. The amount, based on the total weight of the coating composition of the invention, is preferably 0.01 to 20.0 wt %, more preferably 0.05 to 18.0 wt %, very preferably 0.1 to 16.0 wt %, especially preferably 0.1 to 14.0 wt %, more particularly 0.1 to 12.0 wt %, and most preferably 0.1 to 10.0 wt %.

### Method for Producing the Aqueous Coating Composition

The present invention further provides a method for producing the coating composition of the invention.

The coating composition of the invention may be prepared by first preparing at least one thickener (C), i.e. an aqueous dispersion of at least one polyamide which is obtainable as outlined hereinbefore.

Following this, the resulting aqueous dispersion of the at least one polyamide as thickener (C) is mixed with the further components used in accordance with the invention for producing the coating composition of the invention, namely components (A) and (B) and also, optionally, (D), (E), organic solvents and optionally further water, by means of high-speed stirrers, stirred tanks, agitator mills, dissolvers, kneading devices, or in-line dissolvers, for example.

### Use

A further subject of the present invention is a use of the coating composition of the invention for at least partly coating an optionally coated substrate with a basecoat film.

Examples of suitable substrates include articles made of metal or plastic that are to be coated, such as bodies and parts thereof, produced therefrom, of motor vehicles such as automobiles, trucks, motorcycles, and buses, and parts of electrical household appliances, produced from metal or plastic.

### Method, Basecoat Film, and Substrate

A further subject of the present invention is a method for at least partly coating an optionally coated substrate with a basecoat film, comprising at least one step (a):

(a) at least partly coating at least one optionally coated substrate with a basecoat film with the aqueous coating composition of the invention.

Step (a) here takes place by at least partial contacting of the substrate with the coating composition of the invention.

Step (a) may optionally be followed by a further step (b), this being the application of a further coating film, preferably a clearcoat film, to the basecoat film applied by step (a). In that case the method of the invention is a method for producing a multicoat paint system.

A further subject of the present invention is a basecoat film which is obtainable by at least partly coating at least one optionally coated substrate with the aqueous coating composition of the invention, or which is obtainable by the method of the invention.

A further subject of the present invention is a substrate coated at least partly with the aqueous coating composition of the invention or with the basecoat film of the invention.

The coating composition of the invention may be applied here directly or after the preceding at least partial application of a primer coating composition, such as a cationically electrodepositable coating composition (cathodic electrocoat material), and, where necessary, after the at least partial application of a further coating composition to the cathodic electrocoat, to the articles that are to be coated. This is followed preferably by drying of these coating films. The coating composition of the invention is applied preferably as a paint system to automotive bodies and parts thereof. The metallic articles to be coated are preferably subjected beforehand to chemical treatment with phosphates and chromates, preferably phosphates such as metal phosphates, more particularly zinc phosphates. Moreover, known, conventional materials may be employed as undercoating compositions and as intermediate-coating compositions.

The coating composition of the invention may be coated onto these target substrates (including those which have optionally been at least partly coated with the undercoating composition and which, moreover, in a suitable way have been optionally coated at least partly with the intermediate-coating composition) by electrostatic coating, by air-spray coating, and by airless spray coating. The thickness of the resultant coating film thereof is preferably in a range from 5 to 35 μm, more particularly 10 to 25 μm, as cured coating film. The coating film may be dried, for example, by heating for 2 to 40 minutes, preferably 5 to 20 minutes, at 50 to 100° C. (oven temperature).

A clear coating composition may be coated onto the coating film of the coating composition of the invention, after it has cured or without it being cured, i.e., onto a coated side thereof, by a “twice coat once cure” (2-cure 1-bake) process or a “twice coat twice cure” (2-cure 2-bake) process.

Furthermore, the coating compositions of the invention are also suitable for use in a dual application (wet-on-wet painting) to which, after briefly preliminary drying, a clearcoat material is applied, and is baked together with the films painted first (3C1B).

The clear coating composition for the application of a clearcoat of this kind may be applied by first coating the coating composition of the invention onto the target substrate in the manner described, and by coating the clear coating composition, with a solids content in the coating composition controlled at preferably 30 to 80 wt %, onto a coated surface of said substrate, by means of electrostatic coating, air spray coating, and airless spray coating, after the curing of a coating film thereof by heating, or in an uncured state. The film thickness of the clear coating composition is preferably in a range of commonly 5 to 100 μm, more particularly 20 to 80 μm, based on the cured coating film. The entire coating film may be cured by heating for 10 to 40 minutes at 100 to 180° C.

### Methods of Determination

### 1. Determining the Acid Number

The acid number is determined in accordance with DIN EN ISO 2114 (date: June 2002), using “method A”. The acid number corresponds to the mass of potassium hydroxide in mg which is needed to neutralize 1 g of sample under the conditions specified in DIN EN ISO 2114. The stated acid number corresponds to the total acid number stated in the DIN standard.

### 2. Determining the Nonvolatile Fraction

The nonvolatile fraction (also called solids content) is determined in accordance with DIN EN ISO 3251 (date: June 2008). This determination is accomplished by weighing out 1 g of sample into an aluminum dish dried beforehand and carrying out drying in a drying oven at 130° C. for 60 minutes, followed by cooling in a desiccator, and then by reweighing. The residue, relative to the total amount of the sample employed, corresponds to the nonvolatile fraction.

### 3. Determining Film Thickness

The film thickness of coating films (layers) is determined in accordance with DIN EN ISO 2808 (date May 2007), procedure 12A, via use of MiniTest® 3100-4100 measuring device (ElektroPhysik).

4. Assessment of the Homogeneity or Occurrence of Specks (Bits) after Incorporation of the Polyamide Dispersion into a Test Coating

The mixture of a test coating with a polyamide dispersion according to the invention (or a comparative composition) is visually assessed with regard to the homogeneity of the resulting mixture or with regard to the occurrence of specks (bits). The following criteria shall be used:

### Homogeneity:

It is assessed to what extent a homogeneous mixture forms after 10 minutes of stirring, i.e. whether the test coating and the polyamide dispersions can be mixed to a single-phase mixture on the macroscopic scale or whether two or more phases form during weighing or within a few minutes after stirring due to segregation.

It is assessed qualitatively according to a scale of 1 to 5 (1=very easy to incorporate or very homogeneous/5=very difficult to incorporate or very inhomogeneous).

To validate the incorporation or homogeneity, a commercially available 1 L tin can (diameter: approx. 110 mm/height: approx. 140 mm) is filled with two thirds of the corresponding test coating. After additivation with the respective polyamide dispersion, the mixture is stirred for 10 minutes using a conventional laboratory mixer (for example Vollrath, model EWTHV 0.5) using a Lenart disc (diameter: 65 mm). Care must be taken to ensure that a simplified Reynold number for stirring processes Re′_{R} of a maximum of 1000 is achieved, so that essentially laminar mixing, but no dispersion work by turbulence takes place.

The Reynold number for stirring processes Re_{R} is known in the art; It is defined as

$${Re}_{R} = \frac{\text{?}}{\text{?}} , where$$

$$ρ = density in kg \cdot {m}^{- 3}$$

$$d = diameter of the stirring blade in m$$

$$n = speed in {s}^{- 1} and$$

$$η = dynamic viscosity in kg \cdot {m}^{- 1} \cdot {s}^{- 1}$$

$$\text{?} \text{indicates text missing or illegible when filed}$$

The density of a representative waterborne basecoat was determined on the basis of DIN 53217-2:1991-03. The determined value of 1135 kg·m⁻³ is assumed simplifying for all waterborne basecoats according to the invention and not according to the invention. For the actually shear-dependent dynamic viscosity, a value of 0.1 Pas is assumed for all samples (see, for example, www.chemie.de/lexikon/Viskosit % C3% A4t.html of 29.08.2018), so that the simplified Reynold number for stirring processes Re′_{R} results in the following term:

$$\text{?} = 11350 \cdot s \cdot {m}^{- 2} \cdot {d}^{2} \cdot n$$

$$\text{?} \text{indicates text missing or illegible when filed}$$

### Specks (Bits):

The corresponding test varnish is applied after incorporation of the respective polyamide dispersion by means of a 150 μm box doctor blade on a glass panel measuring 9×15 cm. When wet and after a 60-minute airing time at room temperature (23° C.), the film is visually assessed for specks by holding it against a light source so as not to misinterpret any air pockets as specks. A grade of 1-5 is awarded (1=no specks/5=very many specks).

5. Determination of Stability after Oven Storage/Stirring Test

To determine the storage stability of the coating compositions according to the invention (or of comparative coating compositions) these are stirred before and after storage at 40° C. for a certain time or before and after a stirring test (700 g of material are stirred in a 1 L internally painted and closed with a lid tin can for 21 days in a mixing shelf with a stirring speed n of 20 min−1) with one of DIN 53019-1 (date: September 2008) and calibrated according to DIN 53019-2 (date: February 2001) rotational viscometer under temperature-controlled conditions (23.0° C. +0.2° C.). The corresponding samples are first sheared for 5 minutes with a shear rate of 1000 s−1 (loading phase) and then 8 minutes with a shear rate of 1 s−1 (relief phase). The mean viscosity level during the loading phase (high shear viscosity) and the level after 8 minutes of relief phase (low shear viscosity) are determined from the measurement data and the values before and after loading are compared with each other by calculating the respective percentage changes.

### 6. Assessment of the Appearance of Runners (Sagging Limit)

To determine the tendency for runners of a coating composition according to the invention (or a comparative coating composition) multilayer coatings are produced in accordance with DIN EN ISO 28199-1 (Date: January 2010) and DIN EN ISO 28199-3 (Date: January 2010) according to the following general rule:

A perforated sheet of the dimensions 57 cm×20 cm made of steel coated with a standard EDCoat (CathoGuard® 800 from BASF Coatings GmbH) (according to DIN EN ISO 28199-1, point 8.1, version A) is prepared analogously to DIN EN ISO 28199-1, point 8.2 (version A). Subsequently, based on DIN EN ISO 28199-1, point 8.3, the application of a coating composition according to the invention or a comparative coating composition without stress by means of a rotary atomizer in a single application as a wedge with a target layer thickness (layer thickness of the dried material) in the range of 5 microns to 40 microns. The resulting waterborne basecoat layer is dried after an aeration time at 18-23° C. of 4 minutes in the convection oven for 10 minutes at 70° C. The sheets are aired vertically and dried.

The determination of the rotor inclination is carried out according to DIN EN ISO 28199-3, point 4. In addition to the layer thickness at which a runner exceeds the length of 10 mm from the lower edge of the hole, the layer thickness from which a first runner inclination on a hole can be visually observed is determined.

### 7. Determination of the Displacement of the Color Tone During Storage (Shift of Color)

To determine the shift of the color tone, a coating composition according to the invention (or a comparative composition) is applied before and after storage as a waterborne basecoat on a coated with a primer coating steel sheet of dimensions 32×60 cm by means of a double electrostatic application so that a total layer thickness (dry layer thickness) of 12-17 microns results. After the first application step, a 3-minute ventilation phase at room temperature (18 to 23° C.) takes place; Subsequently, a further electrostatic application step is carried out, the resulting water-based lacquer layer is ventilated for 10 minutes at room temperature and then dried in the convection oven for another 10 minutes at 80° C.

A commercially available two-component clearcoat (ProGloss® from BASF Coatings GmbH) with a dry layer thickness of 40-45 μm is applied to the dried waterborne basecoat layer. The resulting clear coat is aired for a period of 10 minutes at room temperature (18 to 23° C.). It is then cured in a convection oven at 140° C. for a further 20 minutes. The correspondingly coated substrate is measured using a spectrophotometer from X-Rite (X-Rite MA68 Multi-Angle Spectrophotometer). The surface is illuminated with a light source. At different angles, spectral detection is carried out in the visible range. From the spectral measured values obtained in this way, color values in the CIEL*a*b* color space can be calculated, taking into account the standard spectral values and the reflection spectrum of the light source used, wherein L* characterize the brightness, a* the red-green value and b* the yellow-blue value (see DIN EN ISO 11664-4 of June 2012). This method is described, for example, in ASTM E2194-12 in particular for coatings containing at least one effect pigment as a pigment. The parameter used at this point for the quantification of the hue shift before and after storage of a sample is the mDE* value. This is the color distance DE* (also called Delta E, dE or ΔE) averaged over all detected angles, which is described in DIN EN ISO 11664-4 of June 2012.

### 8. Determination of Adhesion Properties

To determine the adhesion properties of the coating compositions according to the invention (or of comparative compositions), multilayer coatings are prepared according to the following general rule:

On a metallic substrate of dimensions 10×20 cm coated with a hardened ED-Coat (CathoGuard® 800 from BASF Coatings GmbH), the waterborne basecoat is applied by means of a double pneumatic application, resulting in a total layer thickness (dry layer thickness) of 22-26 μm. A 3-minute airing time at room temperature takes place between the first and second pneumatic application. The resulting waterborne basecoat layer is then dried after a renewed airing time at room temperature of 5 minutes in the convection oven for 10 minutes at 70° C. A commercially available two-component clearcoat (ProGloss from BASF Coatings GmbH) with a target layer thickness of 40-45 μm is applied to the dried waterborne basecoat. The resulting clear coat is aired for 10 minutes at room temperature; then curing takes place in a convection oven at 140° C. for a further 20 minutes.

In order to assess the technological properties, the multi-layer coatings were examined with regard to stone chip adhesion. For this purpose, the stone impact test according to DIN EN ISO 20567-1, method B was carried out. The resulting damage pattern was also assessed in accordance with DIN EN ISO 20567-1. Furthermore, steam jet tests were carried out according to DIN 55662, method B. The crack (St. Andrew's Cross) was attached with a scratch stylus according to Sikkens (see DIN EN ISO 17872 Annex A). The evaluation of the results of the steam jet test was carried out in accordance with DIN 55662.

In addition, steam jet tests according to DIN 55662, method B (attachment of a St. Andrew's cross to a scratch stylus according to Sikkens according to DIN EN ISO 17872 Annex A), were carried out on substrates on which a stone impact test according to DIN EN ISO 20567-1, method B had previously been carried out. The following scale was used for visual evaluation of the damage pattern:
KWO=no change in the sample
KW1=slight leaching of the existing damage
KW2=clearly visible washout of the existing damage in a paint layer
KW3=complete release of a lacquer layer in the area of the blasting plate
KW4=complete release of a lacquer layer beyond the blasting range
KW5=Delamination of the complete paint layer to the substrate

### 9. Assessment of Appearance Before and After Condensation Water Exposure

The evaluation of the course or waviness of the coated substrates is carried out with a wave scan measuring device from Byk/Gardner. The coated substrates are prepared as described in point 8 (Determination of adhesion properties).

For the purpose of assessing the appearance, a laser beam is directed at an angle of 60° onto the surface to be examined, and the lower the values are registered on a measuring distance of 10 cm in the so-called short wave range (0.3 to 1.2 mm) and in the so-called long wave range (1.2 to 12 mm) with the help of the measuring device (long wave=LW; short wave=SW; the lower the values, the better the appearance). In addition, the characteristic “distinctness of image” (DOI) is determined as a measure of the sharpness of an image reflected in the surface of the multilayer structure with the help of the measuring device (the higher the value, the better the appearance). In addition, the value du (“dullness”) is determined (the lower the value, the better appearance).

The corresponding investigations were carried out on the uncontaminated samples as well as after condensation contamination. For this purpose, the coated substrates are stored for a period of 10 days in a climatic chamber according to test climate CH according to DIN EN ISO 6270-2 (date: September 2005). Subsequently, the coated substrates are assessed 2 or 24 hours after removal from the climatic chamber with regard to curve or waviness. In the following, the term CC test (constant climate test) is also used.

### 10. Determining Volume-Based Particle Size Distribution

The volume-based particle size distribution is determined via centrifugation in an optical centrifuge (Dispersion Analyzer “LUMiSizer 651”) in accordance with ISO 13318. The samples (i.e. aqueous dispersions) are diluted with distilled water to a solids content of 0.5% and subsequently stirred for 24 h at room temperature. Afterwards, the samples were once more diluted with distilled water (volume ratio sample/water ¼). Exact measuring conditions were as follows: PA Cuvettes with a 2 mm optical path length, three-fold determination, temperature 25° C., Wavelength 410 nm, speed specification 4000 1/min, dilution 0.5% in water?!?! Evaluation: ×10, ×50 und ×90 quantiles of the volume-based particle size distribution Q3 (x). The particle size distribution was calculated by means of literature values for density and refractive index (Density: 930 kg/m³; Refractive Index: 1.53).

### 12. Determining Melting Point

For the determination of the melting point, DCS was used. For this, a representative 5 mg sample of the sample is prepared according to DIN EN ISO 11357-1. The analytic device is operated according to DIN EN ISO 11357-1 resulting in the corresponding melting point of the analyzed substance.

The inventive and comparative examples below serve to illustrate the invention but should not be interpreted as imposing any restriction.

### Inventive and Comparative Examples

Unless indicated otherwise, the amounts in parts are parts by weight, and the amounts in percent are percentages by weight, in each case.

### 1. Preparing Intermediate Products

### 1.1 Preparing a Talcum Paste P1

Paste P1 was prepared from 24.0 parts by weight (pbw) of polyester resin (prepared according to Example D, column 16, lines 37-59 of DE 40 09 858 A1), 24.9 pbw of talcum (Microtalc IT extra, Mondo Minerals B.V.), 0.4 pbw 2,4,7,9,—Tetramethyl-5-Decindiol, 3.4 pbw butyl di glycol, 1.1. pbw of 10% dimethyl ethanol amine in water and 46.2 pbw of distilled water.

### 1.2 Preparing a Barium Sulfate Paste P2

Paste P2 was prepared from 39 pbw of polyurethan dispersion (prepared according to EP 0228003 B2, page 8, lines 6-18), 54 pbw of barium sulfate (Blanc fix micro, Sachtleben Chemie GmbH), 3.7 pbw of butyl glycol, 0.3 pbw Agitan 282 (Münzing GmbH) and 3 pbw of distilled water.

### 2. Preparing a Polyamide PA1

Polyamide PA1 is prepared by introducing 1650 g dimerized fatty acid (commercially available product Pripol® 1012 from Croda) and xylol (49.6 g) into a 5 L reactor with water separator under stirring. The mixture is heated to 60° C. and, subsequently, hexamethylene diamine (232.40 g) is introduced portion-wise. The reactor is heated to 170° C. and hold at that temperature until the acid number is below 63 mg KOH/g. Then, the product is cooled to 60° C. and neutralized with DMEA (160,25 g, meaning that 100% neutralization is reached).

PA1 has an acid number of 56 mg KOH/g, a solids content of 89%, a number average molecular weight (measured by GPC) of 1222 g/mol and a melting point of 60° C.

### 3. Preparing Aqueous Polyamide Dispersions

3.1 Preparing a dispersion PAV1a via batch procedure

Polyamide PA1 (599,4 g) is introduced into a 5 L reactor under stirring and heated to 90° C. To the melted polyamide, distilled water (3550 g) is added dropwise under stirring within 2 hours. Afterwards, the reactor is cooled, and the resulting dispersion released. The solids content is 12.7%. The product is a transparent, lightly opaque mixture. Detection of particles was not possible, meaning that the dispersion may be called a solution (cf. also Table 1 below).

### 3.2 Preparing a Dispersion PAV6a Via Continuous Jet Production

Polyamine PA1 (120-130° C.) and distilled water (110° C., under pressure) are heated separately. Then, jet streams of PA1 and water are continuously led into a jet reactor (jet sizes: 300 μm (PA1) and 200 μm (water) via pumps. The jets and thus polyamide and water are continuously dispersed (mixed) within the reactor and then released from the reactor via an outlet of the reactor. After the mixing process, the dispersion is rapidly cooled to room temperature. The solids content of the resulting dispersion is adjusted by the pump rates of water and polyamide jets, respectively.

Dispersion PAV6a has a solids content of 13% (pump PA1:242 rpm (100-115 bar), pump water: 1070 rpm (150-160 bar)). The particle size distribution (volume-based) is described by an×10 quantile of 69 nm, an×50 quantile of 123 nm and an×90 quantile of 455 nm.

Further polyamide dispersions (differing in solids content and thus also water content) were prepared according to the procedures described under 3.1 and 3.2. Thereby, the dispersions PAV2a and PAV5a were prepared according to procedure 3.1, while PAV3a, PAV4a, PAV 5a and PAV 7a were prepared according to procedure 3.2. Table 1 gives an overview.

TABLE 1
Polyamide dispersions PAV1a to PAV7a

| | PAV1a | PAV2a | PAV3a | PAV4a | PAV5a | PAV6a | PAV7a |
|---|---|---|---|---|---|---|---|
| Polyamide PA1 | 12.7 | 24.7 | 14.6 | 28.4 | 15.2 | 13.8 | 24.6 |
| Distilled water | 87.3 | 75.3 | 85.4 | 71.6 | 84.8 | 86.2 | 75.4 |
| Sum | 100.0 | 100.0 | 100.0 | 100.0 | 100.0 | 100.0 | 100.0 |
| Solids content [%]: | 12.7 | 24.7 | 14.6 | 28.4 | 15.2 | 13.8 | 24.6 |
| Particle size | Solution | Solution | X10: 88 | X₁₀: 43 | Solution | X₁₀: 69 | X₁₀: 103 |
| distribution: | | | X50: 119 | X₅₀: 63 | | X₅₀: 123 | X₅₀: 270 |
| | | | X90: 242 | X₉₀: 592 | | X₉₀: 455 | X₉₀: 1690 |

Furthermore, commercially available aqueous polyamide dispersions were investigated in view of their particle size distribution. Table 2 gives the details.

TABLE 2
commercial polyamide dispersions

| | ×10 [nm] | ×50 [nm] | ×90 [nm] |
|---|---|---|---|
| Disparlon AQ600 | 67 | 1004 | 3638 |
| Disparlon AQ633E | — | — | — |

### 4. Preparing Polyamide Slurries PS

Different polyamide slurries are prepared from versatile of the above aqueous polyamide dispersions. For this, the constituents listed in Table 3 are mixed in the given order under stirring. After a final step of 10 minutes intensive stirring, a homogenous polyamide slurry is formed.

TABLE 3
Polyamide slurries

| | PS2a | PS4a | PS6a | PS7a | PSD |
|---|---|---|---|---|---|
| PAV2a | 71.5 | | | | |
| PAV4a | | 39.7 | | | |
| PAV6a | | | 10.0 | | |
| PAV7a | | | | 39.7 | |
| Disparlon ® AQ-633E (Kusomoto | | | | | 57.5 |
| Chemicals, Ltd. | | | | | |
| Butyl glycol | | 4.0 | 5.0 | 4.0 | |
| Dimethyl ethanol amine (10% in | | 0.6 | | 0.6 | |
| water) | | | | | |
| 2,4,7,9-Tetramethyl-5-decindiol, | 1.3 | 1.2 | | 1.2 | 3.0 |
| (52% in Butyl glycol (erhältlich von | | | | | |
| BASF SE) | | | | | |
| Distilled water | 27.2 | 54.6 | 85.0 | 54.6 | 39.6 |
| Sum: | 100.0 | 100.0 | 100.0 | 100.0 | 100.0 |
| Solids content [%]: | 18.3 | 11.9 | 10.0 | 10.4 | 14.5 |

### 5. Preparing Aqueous Preparations for Production of Coating Compositions PL1 And PL2

The constituents listed in Table 4 were mixed in the given order under stirring. Afterwards, it was stirred for another 10 minutes and the preparations were adjusted to an pH of 8.5 and an application viscosity of 100±15 mPa·s (shear stress of 1000 s⁻¹, measured via Rheolab QC/C-LTD80/QC, Anton Paar) by means of water and di ethanol amine.

TABLE 4
preparations for production of coating compositions

| | PL1 | PL2 |
|---|---|---|
| Distilled water | 9.1 | 2.8 |
| 2-Ethyl hexanol | 3.0 | 3.8 |
| Aqueous binder dispersion, produced according to example | 55.2 | 17.3 |
| “BM2”, of EP 3 247 755 B1 | | |
| Aqueous polyurethan-polyurea-dispersion prepared in | | 35.7 |
| accordance with example “D1” of EP 3 229 976 B1 | | |
| Polyester prepared according to example BE1 of WO | 4.7 | 5.9 |
| 2014/033135 A2 | | |
| Rheovis ® AS 1130 (BASF SE) | 0.4 | 0.5 |
| Distilled Wasser | 1.5 | 1.9 |
| Cymel ® 203 (Allnex) | 10.5 | 13.1 |
| Dimethyl ethanol amine (10% in distilled water) | 0.2 | 0.2 |
| 2,4,7,9-Tetramethyl-5-decindiol, 52% ig in butyl glycol | 0.6 | 0.2 |
| (BASF SE) | | |
| Butyl glycol | 6.1 | 7.6 |
| Rheovis ® PU1250 (BASF SE) in Butyl glycol (50%) | 0.2 | 0.2 |
| Distilled water | 8.7 | 10.9 |
| Sum: | 100.0 | 100.0 |

### 6. Preparing Aqueous Coating Compositions

Aqueous coating compositions were prepared according to Tables 5.1 and 5.2 (whereby the listed constituents were mixed in this order and then stirred for 10 minutes).

TABLE 5.1

| | WBL1 | WBL2 | WBL3 | WBL4 | WBL5 |
|---|---|---|---|---|---|
| PL1 | 85.7 | 85.7 | 85.7 | 85.7 | 85.7 |
| PAV1a | 14.3 | | | | |
| PS2a | | 14.3 | | | |
| PSD | | | 14.3 | | |
| PAV3a | | | | 14.3 | |
| PS4a | | | | | 14.3 |
| Sum: | 100.0 | 100.0 | 100.0 | 100.0 | 100.0 |
| Solids content [%]: | 25.0 | 24.9 | 25.3 | 25.8 | 25.3 |

TABLE 5.2

| | WBL6 | WBL7 | WBL8 | WBL9 | WBL10 |
|---|---|---|---|---|---|
| PL2 | 85.7 | 85.7 | 85.7 | 85.7 | 85.7 |
| PAV1a | 14.3 | | | | |
| PS2a | | 14.3 | | | |
| PSD | | | 14.3 | | |
| PAV3a | | | | 14.3 | |
| PS4a | | | | | 14.3 |
| Sum: | 100.0 | 100.0 | 100.0 | 100.0 | 100.0 |
| Solids content [%]: | 30.5 | 30.4 | 30.8 | 31.3 | 30.8 |

Also, aqueous coating compositions WBL11 and WBL12 are prepared as outlined below (including Table 6). At first, the constituents listed in Table 6 under “aqueous phase” are mixed in the given order. Then, an aluminium premixture is formed as outlined in Table 6 and admixed with the aqueous phase. Finally, it is stirred for 10 minutes and the preparations are adjusted to an pH of 8.2 and an application viscosity of 105±15 mPa·s (shear stress of 1000 s⁻¹, measured via Rheolab QC/C-LTD80/QC, Anton Paar) by means of water and diethanolamine.

TABLE 6
WBL 11 and 12

| | WBL11 | WBL12 |
|---|---|---|
| Aqueous phase: | | |
| Distilled water | 12.4 | 8.5 |
| 2-Ethyl hexanol | 2.00 | 2.00 |
| Aqueous binder dispersion, produced according to | 36.40 | 36.40 |
| example “BM2”, of EP 3 247 755 B1 | | |
| Polyester prepared according to example BE1 of WO | 3.10 | 3.10 |
| 2014/033135 A2 | | |
| Rheovis ® AS 1130 (BASF SE) | 0.25 | 0.25 |
| Distilled water | 0.75 | 0.75 |
| Cymel ® 203 (Allnex | 6.90 | 6.90 |
| Dimethyl ethanol amine (10% in distilled water) | 0.10 | 0.10 |
| 2,4,7,9-Tetramethyl-5-decindiol, 52% ig in butyl | 0.40 | 0.40 |
| glycol (BASF SE) | | |
| Butyl glycol | 4.00 | 4.00 |
| Rheovis ® PU1250 (BASF SE) in Butyl glycol (50%) | 0.10 | 0.10 |
| Polyamid dispersion PAV5a | 13.15 | |
| Polyamid dispersion PS6a | | 20.00 |
| Aluminium pigment premixture | | |
| Mixture of two commercial aluminium pigments | 7.7 | 7.7 |
| (Altana-Eckart, Stapa ® Hydrolux 2192 and Hydrolux | | |
| 2156 in a ratio of 3:1) | | |
| Butyl glycol | 3.30 | 3.30 |
| Butyl di glycol | 2.80 | 2.80 |
| Polyester; prepared according to Example D, of DE | 3.50 | 3.50 |
| 40 09 858 A1 | | |
| Dimethyl ethanol amine (10% in distilled water) | 0.25 | 0.25 |
| Sum: | 97.1 | 100.0 |
| Solids content after adjustment of viscosity [%]: | 24.9 | 25.0 |

Also, aqueous coating compositions WBL13 to WBL17 are prepared as outlined below (including Table 7). At first, the constituents listed in Table 6 under “aqueous phase” are mixed in the given order. Then, an aluminium premixture is formed as outlined in Table 6 and admixed with the aqueous phase. Finally, it is stirred for 10 minutes and the preparations are adjusted to an pH of 8.0 and an application viscosity of 85±15 mPa·s (shear stress of 1000 s⁻¹, measured via Rheolab QC/C-LTD80/QC, Anton Paar) by means of water and diethanolamine.

TABLE 7
WBL13 to 17

| | WBL13 | WBL14 | WBL15 | WBL16 | WBL17 |
|---|---|---|---|---|---|
| Aqueous phase | | | | | |
| 3 wt.-% of Laponite (in distilled water) | 14.5 | 14.5 | 14.5 | 14.5 | 14.5 |
| Distilled water | 14.2 | 9.9 | 13.8 | 15.6 | 10.4 |
| 2-Ethyl hexanol | 1.9 | 1.9 | 1.9 | 1.9 | 1.9 |
| Aqueous binder dispersion, produced | 8.8 | 8.8 | 8.8 | 8.8 | 8.8 |
| according to example “BM2”, of EP 3 247 755 | | | | | |
| B1 | | | | | |
| Aqueous polyurethan-polyurea-dispersion | 18.2 | 18.2 | 18.2 | 18.2 | 18.2 |
| prepared in accordance with example “D1” of | | | | | |
| EP 3 229 976 B1 | | | | | |
| Polyester prepared according to example BE1 | 1.5 | 1.5 | 1.5 | 1.5 | 1.5 |
| of WO 2014/033135 A2 | | | | | |
| 3 wt.-% Rheovis ® AS 1130 (BASF SE) in distilled | 1.0 | 1.0 | 1.0 | 1.0 | 1.0 |
| water, | | | | | |
| Cymel ® 303 (Allnex) | 4.7 | 4.7 | 4.7 | 4.7 | 4.7 |
| 2,4,7,9-Tetramethyl-5-decindiol, 52% ig in butyl | 0.1 | 0.1 | 0.1 | 0.1 | 0.1 |
| glycol (BASF SE) | | | | | |
| Rheovis ® PU1250 (BASF SE) in Butyl glycol | 0.1 | 0.1 | 0.1 | 0.1 | 0.1 |
| (50%) | | | | | |
| Polyamid dispersion PAV5a | 8.3 | | | | |
| Polyamid dispersion PS6a | | 12.6 | | | |
| Polyamid dispersion PSD | | | 8.7 | | |
| Polyamid dispersion PAS2a | | | | 6.9 | |
| Polyamid dispersion PS7a | | | | | 12.1 |
| Iso tridecyl alcohol | 3.4 | 3.4 | 3.4 | 3.4 | 3.4 |
| K-FLEX UD-350W (King Industries Inc.) | 2.6 | 2.6 | 2.6 | 2.6 | 2.6 |
| Tego ® Wet 510 (Evonik) | 0.4 | 0.4 | 0.4 | 0.4 | 0.4 |
| BYK-346 (BYK-Chemie GmbH) | 0.1 | 0.1 | 0.1 | 0.1 | 0.1 |
| BYK-381 (BYK-Chemie GmbH) | 0.1 | 0.1 | 0.1 | 0.1 | 0.1 |
| Nacure ® 2500 (King Industries, Inc) | 0.2 | 0.2 | 0.2 | 0.2 | 0.2 |
| Talcum paste P1 | 1.3 | 1.3 | 1.3 | 1.3 | 1.3 |
| Barium sulfate paste P2 | 2.4 | 2.4 | 2.4 | 2.4 | 2.4 |
| Aluminium pigment premixture | | | | | |
| Mixture of two commercial aluminium | 6.6 | 6.6 | 6.6 | 6.6 | 6.6 |
| pigments (Altana-Eckart, Stapa ® Hydrolux | | | | | |
| 2192 and Hydrolux 2156 in a ratio of 3:1) | | | | | |
| Butyl glycol | 3.2 | 3.2 | 3.2 | 3.2 | 3.2 |
| Butyl di glycol | 2.8 | 2.8 | 2.8 | 2.8 | 2.8 |
| Polyester; prepared according to Example D, | 3.3 | 3.3 | 3.3 | 3.3 | 3.3 |
| of DE 40 09 858 A1 | | | | | |
| Dimethyl ethanol amine (10% in distilled | 0.2 | 0.2 | 0.2 | 0.2 | 0.2 |
| water) | | | | | |
| Sum: | 100.00 | 100.00 | 100.00 | 100.00 | 100.00 |
| Solids content after adjustment of viscosity | 28.4 | 27.5 | 28.7 | 28.2 | 28.5 |
| [%]: | | | | | |

Table 8 gives an overview of the total set of aqueous coating compositions (basecoat formulations) prepared according to the above working examples. For better comparability, the compositions are differentiated by inventive and comparative character. Consequently, it is also provided which polyamide dispersion is comprised (either directly or via an intermediate, i.e. a polyamide slurry). Inventive WBLs are marked by an asterisk (*).

TABLE 8
Total set of produced coating compositions (Basecoat formulations)

| Number of | Polyamide | | |
|---|---|---|---|
| WBL | dispersion | Inventive | Comparative |
| WBL1 | PAV1a | | X |
| WBL2 | PAV2a | | X |
| WBL3 | Disparlon ® | | X |
| | AQ-633E | | |
| WBL4* | PAV3a | X | |
| WBL5* | PAV4a | X | |
| WBL6 | PAV1a | | X |
| WBL7 | PAV2a | | X |
| WBL8 | Disparlon ® | | X |
| | AQ-633E | | |
| WBL9* | PAV3a | X | |
| WBL10* | PAV4a | X | |
| WBL11 | PAV5a | | X |
| WBL12* | PAV6a | X | |
| WBL13 | PAV5a | | X |
| WBL14* | PAV6a | X | |
| WBL15 | Disparlon ® | | X |
| | AQ-633E | | |
| WBL16 | PLV2a | | X |
| WBL17* | PAV7a | X | |

### 7. Performance Test of Coating Compositions and Coating Films Produced Therefrom

WBL1 to WBL 5 as well as WBL6 to WBL10 were investigated in terms of homogeneity and bits in accordance with the above-described methods. Tables 9.1 and 9.2 shows the result.

TABLE 9.1

| | WBL1 | WBL2 | WBL3 | WBL4* | WBL5* |
|---|---|---|---|---|---|
| Homogeneity | 1-2 | 2 | 2 | 1-2 | 1-2 |
| Bits | 1 | 1 | 1 | 1 | 1 |

TABLE 9.2

| | WBL6 | WBL7 | WBL8 | WBL9* | WBL10* |
|---|---|---|---|---|---|
| Homogeneity | 1-2 | 2 | 2-3 | 1-2 | 1-2 |
| Bits | 1 | 1 | 1 | 1 | 1 |

The results show that the inventive basecoats show improved homogeneity. Bits were observed in none of the investigated samples.

WBL11 and WBL12 were investigated in terms of sagging behaviour, storage stability, appearance after CC test and adhesion properties in accordance with the above-described method. Also, Tables 9.3 to 9.6 show the results.

TABLE 9.3

| Sagging behavior | | WBL11 | WBL12* |
|---|---|---|---|
| Freshly prepared | Sagging limit(>0 mm): | >30 μm | >30 μm |
| | Sagging limit (>10 mm): | >30 μm | >30 μm |
| After 2 weeks at 40° C. | Sagging limit (>0 mm): | >30 μm | >30 μm |
| | Sagging limit (>10 mm): | >30 μm | >30 μm |

Maximum coating thickness 30 μm.

TABLE 9.4

| | WBL11 | | | | WBL12* | | | |
|---|---|---|---|---|---|---|---|---|
| | Two | Four | Two | Four | Two | Four | Two | Four |
| Storage | weeks | weeks | weeks | weeks | weeks | weeks | weeks | weeks |
| stability | RT | RT | 40° C. | 40° C. | RT | RT | 40° C. | 40° C. |
| Change in | 10% | 11% | −22% | −29% | 5% | 7% | 10% | 5% |
| viscosity [%] | | | | | | | | |
| after storage | | | | | | | | |
| at 1000/s | | | | | | | | |

TABLE 9.5

| Appearance | | WBL11 | WBL12* |
|---|---|---|---|
| LW | 2 hours after CC test | 10.7 | 8.4 |
| | 24 hours after CC test | 6.3 | 5 |
| SW | 2 hours after CC test | 20.9 | 18.8 |
| | 24 hours after CC test | 13.6 | 14.0 |
| DOI | 2 hours after CC test | 86.2 | 87.8 |
| | 24 hours after CC test | 88.5 | 89.8 |
| du | 2 hours after CC test | 17.8 | 13.8 |
| | 24 hours after CC test | 15.4 | 12.2 |

TABLE 9.6

| | WBL11 | WBL12* |
|---|---|---|
| Before condensation water treatment | | |
| Stone ship | 2 | 2 |
| Steamjet on stone ship | KW3 | KW1 |
| Steamjet on scribe | 3A | 1A |
| After condensation water treatment | | |
| Stone ship | 2 | 2 |
| Steamjet on stone ship | KW3 | KW0 |
| Steamjet on scribe | 3A | 1A |

The results confirm that inventive system WBL12 performs significantly better on storage stability, appearance after CC test as well as adhesion behaviour.

Next, WBL13 to WBL15 were investigated in terms of storage stability, adhesion, sagging behavior and shift of color at storage according to the above-described methods. Tables 9.7 to 9.10 show the results.

TABLE 9.7

| | WBL13 | | WBL14* | | WBL15 | |
|---|---|---|---|---|---|---|
| | Four | Four | Four | Four | Four | Four |
| Storage | weeks | weeks | weeks | weeks | weeks | weeks |
| stability | RT | 40° C. | RT | 40° C. | RT | 40° C. |
| Change in | 4% | −46% | 1% | −18% | 13% | −27% |
| viscosity [%] | 4% | −66% | 3% | −13% | 31% | −44% |
| after storage | | | | | | |
| at 1000/s | | | | | | |

TABLE 9.8

| Adhesion properties | WBL13 | WBL14* |
|---|---|---|
| Stone ship | 2 | 2 |
| Steamjet on stone ship | KW3 | KW1 |
| Steamjet on scribe | 3A | 1C |

TABLE 9.9

| Shift of color (Two weeks 40° C.) | WBL13 | WBL14* | WBL15 |
|---|---|---|---|
| mDE* | 9.6 | 3.0 | 3.5 |

TABLE 9.10

| Sagging behavior | | WBL13 | WBL14* | WBL15 |
|---|---|---|---|---|
| Freshly | sagging limit (>0 mm): | >30 μm | >30 μm | >30 μm |
| prepared | sagging limit (>10 mm): | >30 μm | >30 μm | >30 μm |
| After 2 weeks | sagging limit (>0 mm): | >45 μm | >45 μm | >45 μm |
| at 40° C. | sagging limit (>10 mm): | >45 μm | >45 μm | >45 μm |

Maximum coating thickness “fresh” 30 μm.
Maximum coating thickness “after two weeks” 45 μm.

The results show that inventive system WBL14 is significantly better on storage stability, adhesion properties and also resistance to color shift.

Finally, WBL16 and WBL17 were investigated in terms of sagging behavior, appearance before and after CC test and also color shift.

The results are shown in Tables 9.11 to 9.13.

TABLE 9.11

| Sagging behavior | | WBL16 | WBL17* |
|---|---|---|---|
| Freshly prepared | sagging limit (>0 mm): | >30 μm | >30 μm |
| | sagging limit (>10 mm): | >30 μm | >30 μm |
| After 2 weeks at 40° C. | sagging limit (>0 mm): | >45 μm | >45 μm |
| | sagging limit (>10 mm): | >45 μm | >45 μm |

Maximum coating thickness “fresh” 30 μm.
Maximum coating thickness “after two weeks” 45 μm.

TABLE 9.12

| Shift of color (Two weeks 40° C.) | WBL16 | WBL17* |
|---|---|---|
| mDE* | 9.6 | 3.0 |

TABLE 9.13

| Appearance | | | WBL16 | WBL17* |
|---|---|---|---|---|
| LW | Fresh material | Before CC Test | 3.2 | 3.2 |
| | After two weeks | Before CC Test | 4.8 | 4.1 |
| | storage | 24 hours after | 4.7 | 4 |
| | at 40° C. | CC Test | | |
| SW | Fresh material | Before CC Test | 13.6 | 12.5 |
| | After two weeks | Before CC Test | 17.9 | 16.8 |
| | storage | 24 hours after | 14.5 | 14.7 |
| | at 40° C. | CC Test | | |
| DOI | Fresh material | Before CC Test | 87.6 | 87.9 |
| | After two weeks | Before CC Test | 86.9 | 87.6 |
| | storage | 24 hours after | 79.8 | 83.5 |
| | at 40° C. | CC Test | | |
| du | Fresh material | Before CC Test | 16.7 | 15.7 |
| | After two weeks | Before CC Test | 16.0 | 14.7 |
| | storage | 24 hours after | 32.2 | 24.7 |
| | at 40° C. | CC Test | | |

Again, the results show that the inventive system performs significantly better on appearance as well as color shift.

Overall, the results clearly show the technical advantages of the inventive coating compositions and basecoats, respectively, when compared to systems not fulfilling the requirements with regard to the particle size distribution of the aqueous dispersion of polyamide.

1. An aqueous coating composition comprising:
at least one binder (A) comprising at least one polymeric resin (A1) and optionally at least one crosslinking agent (A2),
at least one pigment (B), and
at least one thickener (C),
for at least partly coating an optionally coated substrate with a basecoat film,
wherein the thickener (C) is an aqueous dispersion of a polyamide having a volume-based particle size distribution having an×10 quantile of at least 30 nm, an×50 quantile of at least 60 nm and an×90 quantile of at most 2000 nm.

2. The coating composition according to claim 1, wherein the at least one thickener (C) is an aqueous dispersion of a polyamide having a volume-based particle size distribution having an×10 quantile in a range from 30 to 120 nm, an×50 quantile in a range from 60 to 300 nm and an×90 quantile in a range from 200 to 2000 nm.

3. The coating composition according to claim 1, which has a solids content, in terms of the at least one polyamide in the at least one thickener (C), in a range from 0.5 to 15 wt %, based on the total weight of the coating composition.

4. The coating composition according to claim 1, wherein the polyamide in the thickener (C) has an acid number in a range from 30 to 120 mg of KOH per g of (C).

5. The coating composition according to claim 1, wherein the polyamide in the thickener (C) is at least obtainable obtained by a reaction of at least one polycarboxylic acid selected from the group consisting of aliphatic C₃-C₂₂ dicarboxylic acids, polymers of aliphatic C₁₄-C₂₂ monocarboxylic acids, and mixtures thereof, with at least one aliphatic C₂-C₁₂ diamine.

6. The coating composition according to claim 1, wherein the polyamide in the thickener (C) has a melting point in the range from 50° C. to 120° C.

7. The coating composition according to claim 1, wherein the pigment (B) comprises at least one effect pigment.

8. The coating composition according to claim 1, wherein the binder (A) comprises at least one polyurethane and/or at least one poly(meth)acrylate and/or at least one polyester as at least one polymeric resin (A1).

9. The coating composition according to claim 8, wherein the binder (A) comprises at least one polyurethane and at least one poly(meth)acrylate as polymeric resin (A1).

10. The coating composition according to claim 9, wherein the binder (A) further comprises at least one polyester as polymeric resin (A1).

11. The coating composition according to claim 1, further comprising at least one thickener (D) selected from the group consisting of metal silicates, thickeners based on poly(meth)acrylic acid, thickeners based on polyurethanes, polymeric waxes, and mixtures thereof.

12. The coating composition according to claim 1, wherein the aqueous dispersion of the at least one polyamide as aqueous dispersion of the at least one thickener (C) is produced via continuous production wherein
(i) jet streams of water and polyamide are continuously led into a reactor via an inlet into the reactor,
(ii) the jet streams of water and polyamide are continuously dispersed within the reactor, and
(iii) the produced aqueous dispersion continuously exits the reactor via an outlet of the reactor,
to result in a respective aqueous polyamide dispersion.

13. A method of producing an aqueous coating composition according to claim 1 comprising:
(I) preparing an aqueous dispersion of the at least one thickener (C) which is an aqueous polyamide dispersion having a volume-based particle size distribution having an×10 quantile of at least 30 nm, an×50 quantile of at least 60 nm and an×90 quantile of at most 2000 nm, and
(II) mixing the aqueous dispersion of the at least one thickener (C) with the further constituents of the coating composition.

14. The method according to claim 13, wherein step (I) is conducted via continuous production in which wherein
(i) jet streams of water and polyamide are continuously led into a reactor via an inlet into the reactor,
(ii) the jet streams of water and polyamide are continuously dispersed within the reactor, and
(iii) the produced aqueous dispersion continuously exits the reactor via an outlet of the reactor,
to result in a respective aqueous polyamide dispersion.

15. A method for at least partly coating an optionally coated substrate with a basecoat film, wherein an aqueous coating composition according to claim 1 is used to produce the basecoat film.

16. A basecoat film which is obtainable by at least partly coating at least one optionally coated substrate with the aqueous coating composition according to claim 1.

17. A basecoat film which is obtained by at least partly coating at least one optionally coated substrate with the aqueous coating composition which is obtained by the method according to claim 15.

18. The coating composition according to claim 1, wherein the polyamide in the thickener (C) is at least obtained by a reaction of at least one polycarboxylic acid selected from the group consisting of aliphatic C₃-C₂₂ dicarboxylic acids, dimers of aliphatic C₁₄-C₂₂ monocarboxylic acids, and mixtures thereof, with at least one aliphatic C₂-C₁₂ diamine.

19. The coating composition according to claim 1, wherein the binder (A) comprises at least one polyurethane-poly(meth)acrylate hybrid polymer and/or at least one poly(meth)acrylate and/or at least one polyester as at least one polymeric resin (A1).

20. The coating composition according to claim 19, wherein the binder (A) comprises at least one polyurethane-poly(meth)acrylate hybrid polymer and at least one poly(meth)acrylate as polymeric resin (A1).
